(19) United States
(12) Patent Application Publication
(10) Pub. No.: US 2012/0096542 A1
(43) Pub. Date: Apr. 19, 2012

(54) PORTABLE CONFIDENTIAL ACCOUNT INFORMATION MANAGEMENT DEVICE

(76) Inventor: David P. Shea, New Canaan, CT (US)

(21) Appl. No.: 13/232,982

(22) Filed: Sep. 14, 2011

Related U.S. Application Data
(60) Provisional application No. 61/404,997, filed on Oct. 14, 2010.

(51) Int. Cl. G06F 21/00; H04L 29/06; G06F 12/14

(52) U.S. Cl. 726/16; 726/30

(57) ABSTRACT

In one general aspect, a portable confidential account information management device is disclosed that includes a biometric sensor, keyboard, processor, and storage. The storage includes account information storage including fields that each include an account identifier field and a password field. It also includes program storage including native account management software responsive to the biometric sensor and the keyboard to enable retrieval of contents of the account identifier field and password field for selected accounts. A display screen is responsive to the account management software and operative to display retrieved contents of the account identifier field and the retrieved password field for the selected accounts. In another aspect, removable portable data storage device port is responsive to the storage to store backup copies of information. Disclosed devices can be designed to improve security by isolating them from external access or connectivity.

This application claims the benefit of provisional application No. 61/404,997, filed Oct. 14, 2010, which is herein incorporated by reference.

### FIELD OF THE INVENTION

This application relates to storing confidential account information, such as in a portable biometric device for individuals to securely store and access confidential account password and personal identification number (PIN) information.

### BACKGROUND

Given the increasing trend of business reliance on Internet access for transactions and services, there is a need for individuals to manage increasing amounts of confidential account information. Memorizing vital password and PIN data is difficult, subject to error, potential account lock-out, and password reset. Maintaining handwritten lists is subject to loss or even theft.

Personal digital appliances, personal computers, and smart cell phones have data storage capabilities that can be used to store passwords and account data. Password management software has been developed to make storage of passwords on these devices more secure and convenient. Simpler personal data organizers can also be used to store passwords and account data, and some of these have been marketed as being specifically for this type of use.

### SUMMARY

In one general aspect, the invention features a portable confidential account information management device that includes a biometric sensor, a keyboard, a processor, and storage. The storage includes account information storage including fields that each include an account identifier field and a password field associated with the account identifier field. The device also includes program storage including native account management software that is operative to run on the processor and is responsive to the biometric sensor and to the keyboard to enable retrieval of contents of the account identifier field and the password field for selected accounts. A display screen is responsive to the account management software and operative to display the retrieved contents of the account identifier field and the retrieved password field for each of the selected accounts.

In preferred embodiments the apparatus can further include a power source for the processor, a power switch responsive to the power source, and boot logic responsive to the power switch and operative to run the native account management software upon activation of the power switch. The apparatus can further include clam-shell housing to hold the biometric sensor, keyboard, storage, and display screen, with the power switch being a magnetic switch operative upon opening and closing the clam-shell housing. The apparatus can further include keys whose function is specific to account management functions of the native account management software. The program storage can be non-volatile storage. The program storage can include only a single operating system program that includes the native account management software. The storage can include a closed operating system program that runs the native account management software. The portable confidential account information management device can be isolated from all communication networks. The portable confidential account information management device can be isolated from all wireless networks. The portable confidential account information management device can be isolated from all public networks. The portable confidential account information management device can include no public network communication functionality. The portable confidential account information management device can weighs 0.5 lb or less. The portable confidential account information management device can weighs 1 lb or less. The portable confidential account information management device can weighs 3 lbs or less. The apparatus can further include a navigation control disposed adjacent the display screen and wherein the native account management software is responsive to the navigation control to select accounts for which account information and passwords are displayed. The pointing device can include touch-screen hardware associated with the display. The portable confidential account information management device can include one or more third-party promotional insignia. The native account management software in the program storage can include encryption software to encrypt at least the contents of the password fields in the account information storage, and decryption software to decrypt at least the contents of the password fields in the account information storage. The program storage can include device access software responsive to the keyboard to prompt for and receive a device lockout password from the user and to exclude access to the device unless a predetermined password is received from the user. The program storage can further include AND logic responsive to the device access software and to the biometric sensor to exclude access to the device unless a predetermined combination of device lockout password and biometric information is received from the user. The native account management software in the program storage can include a password generator and wherein the password fields in the account information storage are responsive to the password generator to directly store passwords generated by the password generator. The native account management software in the program storage can include password evaluation logic. The password evaluation logic can be operative to evaluate password strength. The password evaluation logic can be operative to evaluate password length. The native account management software in the program storage can include duplicate password detection software responsive to a plurality of the password fields in the account information storage to detect duplication between passwords stored in the password fields. The apparatus can further include a location detection system. The location detection system can include a GPS receiver and a wireless location reporting transmitter operative to transmit a GPS location signal. The keyboard can be a QWERTY keyboard. A width of the keyboard can be at least about five and one-quarter inches.

In another general aspect, the invention features a password storage method that includes storing passwords in dedicated password storage fields, storing account information in dedicated account information fields, isolating the passwords and the account information from all public networks, and restricting access to the passwords using dedicated password access logic.

In a further general aspect, the invention features a portable confidential account information management device that includes a keyboard, a processor, and storage. The storage includes account information storage that includes fields that each include an account identifier field, and a password field associated with the account identifier field. The storage also includes program storage including native account management software that is operative to run on the processor and is responsive to the keyboard to enable retrieval of contents of the account identifier field and the password field for selected accounts. A display screen is responsive to the account management software and operative to display the retrieved contents of the account identifier field and the retrieved password field for each of the selected accounts. A removable portable data storage device port is responsive to the storage to store backup copies of information stored in the account information storage.

In preferred embodiments the native account management software can have the functionality to create a duplicate of the data memory from the portable confidential account information management device on the portable data storage device as needed. The native account management software can have the functionality to further create a duplicate of existing user settings from the portable confidential account information management device. The native account management software can have the functionality to recover data stored on the portable data storage device as needed. The native account management software can contain security protocol that can only operate with a combination of a specially constructed portable data storage device in conjunction with a unique user-generated access code. The portable confidential account information management device can be constructed to operate in connection with a specially constructed portable data storage device that includes at least one access-restriction feature. The access-restriction feature of the specially constructed portable data storage device can include a proprietary storage format. The access-restriction feature of the specially constructed portable data storage device can include a proprietary form factor. The native account management software can provide secure data back-up and recovery with a security access protocol designed to only interact with a certain portable memory device that contains a unique embedded access code only recognized by the apparatus. An additional level of security for data back-up and recovery operation can be provided by the apparatus native account management software through the creation and recognition of a unique user-generated access code required for the apparatus to conduct any memory back-up and recovery operation.

Systems according to the invention are advantageous in that they can provide ordinary users with a level of confidence in the security of account information that is unsurpassed by prior art devices. Because such devices can be completely isolated from the internet, the cell phone network, and Wi-Fi and Bluetooth connections, the possibility of a network-based attack can be made to be nil without the user needing to manage or even understand digital certificates. And because such systems can encrypt account information, they can be immune from even relatively sophisticated electronic probing even if they are lost or stolen. They can also be provided with secure backup storage and/or secure unlocking capabilities such that data on a lost, broken, or accidentally locked device can be recovered. Biometric capabilities can further substantially enhance the security over and above the other powerful features of systems according to the invention. The robustness and comprehensive nature and level of protection that systems according to the invention can provide is unprecedented.

### BRIEF DESCRIPTION OF THE DRAWINGS

FIG. 1 is a perspective front view of an illustrative portable confidential account information management device in accordance with the invention, in this case a password manager device for consumer use, showing the device in a closed position;

FIG. 2 is a perspective left-side view of the password manager device of FIG. 1 in an opened position;

FIG. 3 is a perspective rear view of the password manager device of FIG. 1 in a closed position;

FIG. 4 is a perspective right-side view of the password manager device of FIG. 1 in an opened position;

FIG. 5 is a perspective view of the password manager device of FIG. 1 showing its upper section taken top down in an opened position;

FIG. 6 is a perspective view of the password manager device of FIG. 1 showing its lower section taken top down in an opened position;

FIG. 7 is a perspective full frontal view of the password manager device of FIG. 1 in an opened and operating position;

FIG. 8 is a perspective side view of the keyboard pen;

FIG. 9 is a perspective view of a second embodiment of a portable confidential account information management device in accordance with the invention taken from the front in its fully open position;

FIG. 10 is a perspective view of the embodiment of FIG. 9 taken from the back in its fully open position;

FIG. 11 is a front elevation view of the embodiment of FIG. 9 in its fully open position;

FIG. 12 is a rear elevation view of the embodiment of FIG. 9 in its fully open position;

FIG. 13 is right side elevation view of the embodiment of FIG. 9 in its fully open position;

FIG. 14 is left side elevation view of the embodiment of FIG. 9 in its fully open position;

FIG. 15 is top view of the embodiment of FIG. 9 in its fully open position;

FIG. 16 is a bottom view of the embodiment of FIG. 9 in its fully open position; and

FIG. 17 is a screenshot of a new password creation screen for the embodiment of FIG. 9.

### DETAILED DESCRIPTION OF AN ILLUSTRATIVE EMBODIMENT

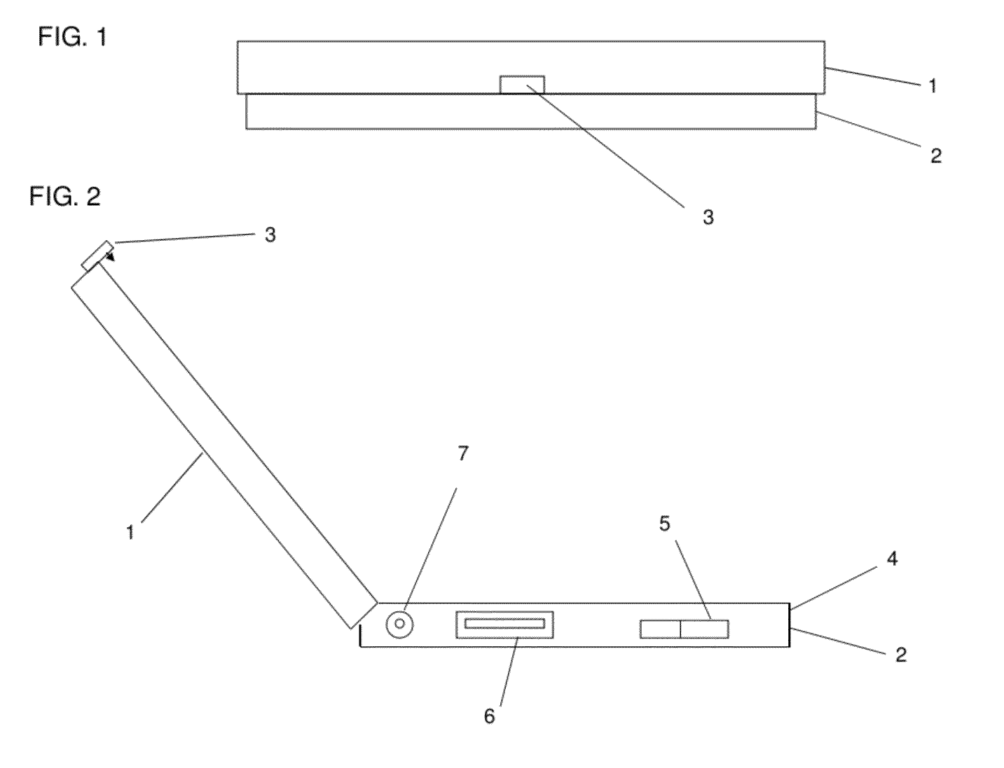

FIG. 1 is a front view taken of an illustrative password manager device in a closed position. The device is contained in a hard molded plastic case and contains an upper section 1 and a lower section 2. There is a metal hasp locking and release mechanism 3 which keeps the password manager device securely closed until opened by the user. The locking hasp 3 is attached to the upper section of the password manager device. In this embodiment, the password manager device must be opened in order to be operated by the user.

FIG. 2 is a left perspective of the password manager device in an opened operating position. The bottom section has utility outlets and a keyboard to that enables the user to operate the device. The hasp locking and release mechanism 3 is shown attached to the front of the upper section 1 and the hasp lock insert 4 is located in the front of the lower section 2. A hold switch 5 when placed in the on position will lock the keyboard and prevent any inadvertent pressing of keys and possible overwriting of important data. The password manager device has an optional port 6 to receive a standard USB plug or portable data storage device. The USB connection in this particular embodiment also enables a connection between the password manager and another device such as a personal computer or cell phone, although for security reasons this is typically not preferable as discussed below. An alternating current power inlet 7 receives a plug from a compatible electrical cord which, when connected, can simultaneously supply power to operate the password manager device and recharge the device's battery system.

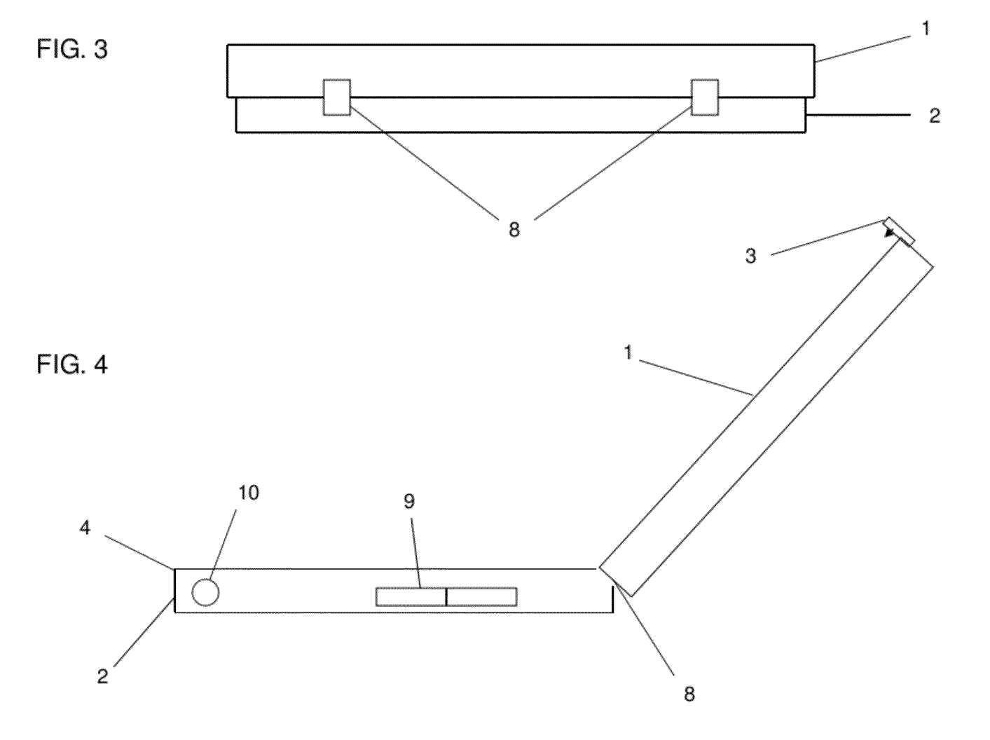

FIG. 3 shows the password device from the back in a closed position. A hinge system 8 allows the device to open in a clamshell-like manner and operate in two sections, the upper 1 and lower 2. When open the password manager device is ready for operation, the hinge system 8 enables the hard molded plastic case to close and protect the device and to open to allow the user to operate the device.

FIG. 4 is a right view of the password manager in an open operating position. An On/Off power switch 9 activates the power supply and also indicates whether power supply is on or off. A storage area 10 is provided to house an optional keyboard pen device 28 that enables the user to press keys on the keyboard in a more efficient manner.

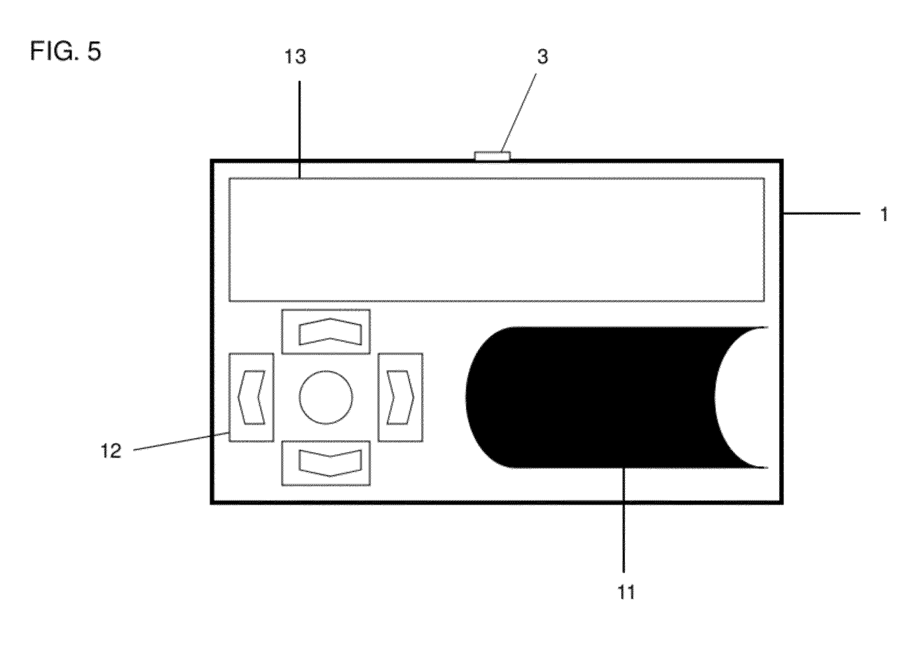

FIG. 5 is a top-down view of the upper section 1 of the password manager device in an open and operating position. The upper section contains a biometric fingerprint reader pad 11 which can control security access to the password device manager. A cursor navigation pad 12 allows the user to manipulate a cursor which appears in the display screen 13 and to operate the operating and database software.

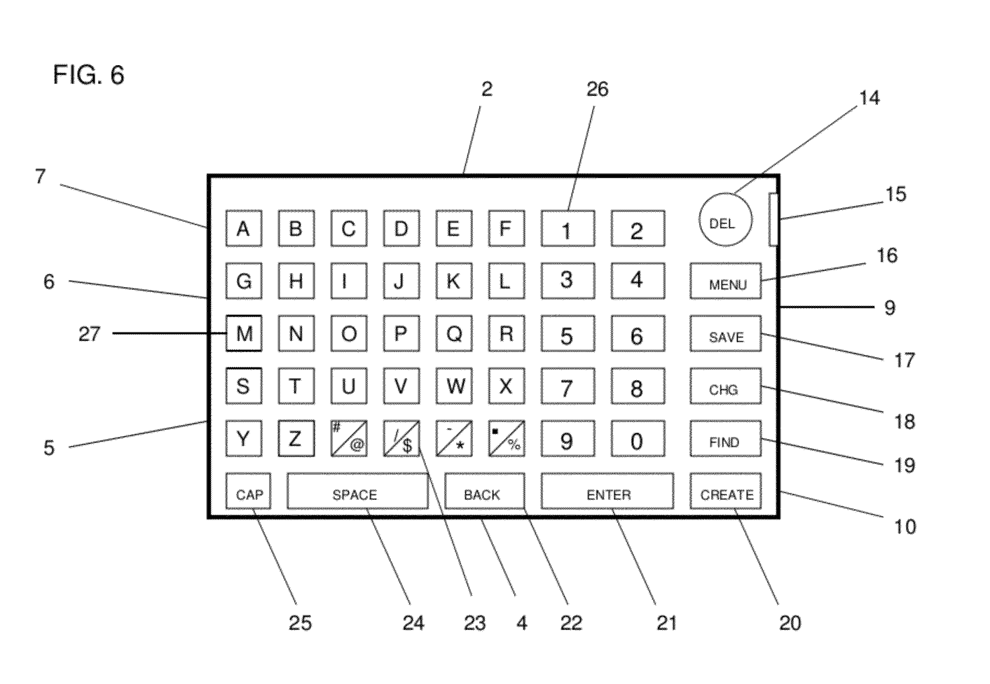

FIG. 6 is a top-down view of the lower section 2 of the password manager device in an open and operating position. The lower section 2 keyboard is a location where the user interacts with the operating and database systems. The keyboard is divided among function, action, alphabetic, numeric and symbol keys. Function keys initiate certain routines that enable the operating or database systems. The functions keys are Menu 16, Change 18, Find 19, and Create 20. The action keys initiate specific commands and include Delete 14, Save 17, Enter 21, Back 22, Space 24 and Capitalization 25. The Capitalization 25 key which when pressed while simultaneously pressing alphabetic keys 27 will create an upper case letter. The Capitalization 25 key which when pressed while simultaneously pressing one of the Symbol keys 23 will create another variant of the symbol key range. There are four Symbol keys 23 that when used in conjunction with the Capitalization key 25 can create a total of eight symbols. The alphabetic keys 27 represent the twenty-six letters in the English alphabet. The ten numeric keys 26 number one to zero. The power status light indicator 15 indicates whether the power is on or off, when recharging is necessary and when the device is connected to an AC power source.

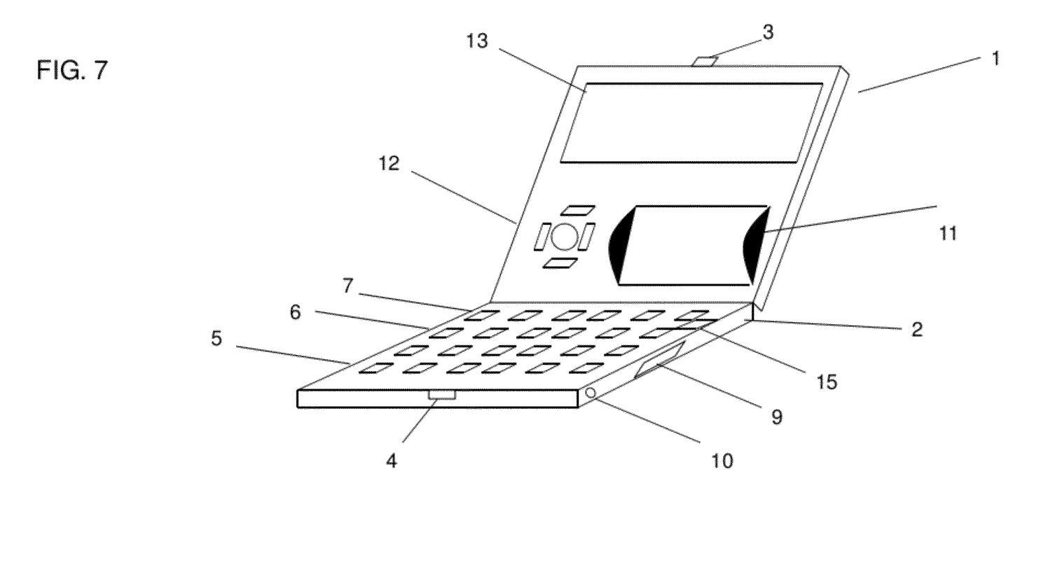

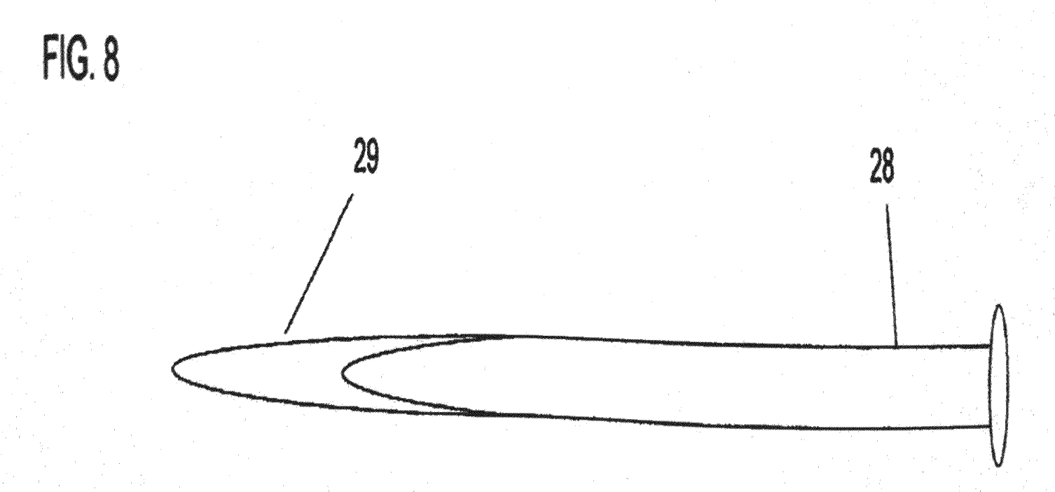

FIG. 7 is a full view of the password device manager from the front in an open and operating position. This view highlights the clamshell-type of opening and closing action of the case and how the upper 1 and lower 2 sections combine for presentation to the user.

FIG. 8 is a side view perspective of the keyboard pen 28 which has a synthetic tip 29 that provides firmer non-slip contact between the keyboard pen and the keys on the password manager device's keyboard.

### REFERENCE NUMERALS

1. Upper section plastic molded case
2. Lower section plastic molded case
3. Hasp locking and release mechanism
4. Hasp lock insert
5. Keyboard hold switch
6. USB port
7. AC power inlet
8. Hinge
9. On/Off power switch
10. Holder for keyboard pen
11. Biometric fingerprint reader pad
12. Cursor navigation pad
13. Display screen
14. Delete action key
15. Power status indicator light
16. Menu function key
17. Save action key
18. Change function key
19. Find function key
20. Create function key
21. Enter action key
22. Back action key
23. Symbol key
24. Space action key
25. Capitalization key
26. Numeric key
27. Alphabetic key
28. Keyboard pen
29. Synthetic rubber tip

### OPERATION

When the hasp release 3 on the front of the password manager device is opened, the power system needs to be charged prior to operation via the AC power inlet (FIG. 2). A user can then initialize the biometric security 11 to create a fingerprint impression on the pad (FIG. 5) to establish security access to the operating system. After this, the biometric security process is repeated each time the password manager device power system is activated or comes out of power hibernation. Prompts and results of user chosen functions and actions are presented on a display screen 13 position (FIG. 5) in the upper section. A user navigates the device's data records through the cursor navigation pad 12 (FIG. 5) located on the upper section. Once the user has access to the keyboard (FIG. 6) and system functions and utilities, operation can commence:
(1) Create function 20 initializes data records that contain confidential password and personal account information.
(2) Find function 19 retrieves data records for the user to read previously created and stored information.
(3) Change function 18 permits data records or fields within the data record to be changed or edited.
(4) Menu function 16 allows the user to access settings that manage power, set display brightness, set audio warnings, create a back-up file or retrieve deleted files.
(5) Action keys Save 17, Delete 14, Enter 21, Space 24, Back 22 and Capitalization 25 execute user commands based on the desired outcome.
(6) The twenty-six alphabetic keys 27, ten numeric keys 26 and four symbol keys 23 located on the keyboard allow the user to input data with the keyboard pen 28 as needed.
(7) Using a portable memory storage device a user connects it to the password manager device's USB port 6 to create a back-up to be stored in a highly secure location. A proprietary storage unit, such as a custom flash card can also be used for the back-up.

The portable electronic device is specifically designed to improve security and management of personal passwords and confidential account information. Improvements include portability with biometric security and custom designed software and functionality. The device opens in a clamshell-like fashion to present an upper section that has a fingerprint security reader, large display screen and cursor navigation. The upper section is ergonomically designed so the user's thumbs can access the fingerprint reader and operate the cursor navigation. The lower section contains a keyboard and several utilities to support the device's operation. The keyboard is designed to be easier to see and facilitate the input of data into the system manually using the specially designed keyboard pen.

There can be different ways to use the biometric sensor. These include biometric only, biometric-password combination, biometric or password, and password only (biometric sensor disabled). The biometric-password provides mode provides the most security, but users may prefer one or more of the other modes.

Accordingly incorporating biometric technology into a portable password manager can improve security while enabling ease of access to personal data. The custom database software makes the management of confidential information more efficient. The keyboard is divided between alpha-symbol and numeric keys and unique function commands. The entire management of the device is presented in a more intuitive manner which improves viewing, reading and operating. The power supply and maintenance allows flexibility of operation with audio warnings of power depletion. Still further advantages will be apparent from a study of the above description and accompanying drawings.

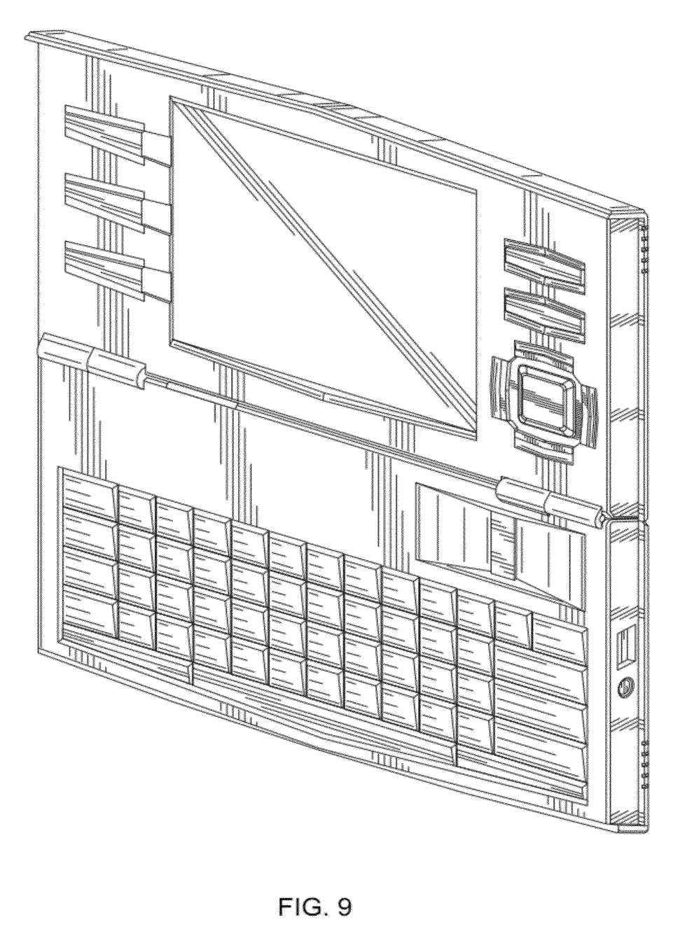

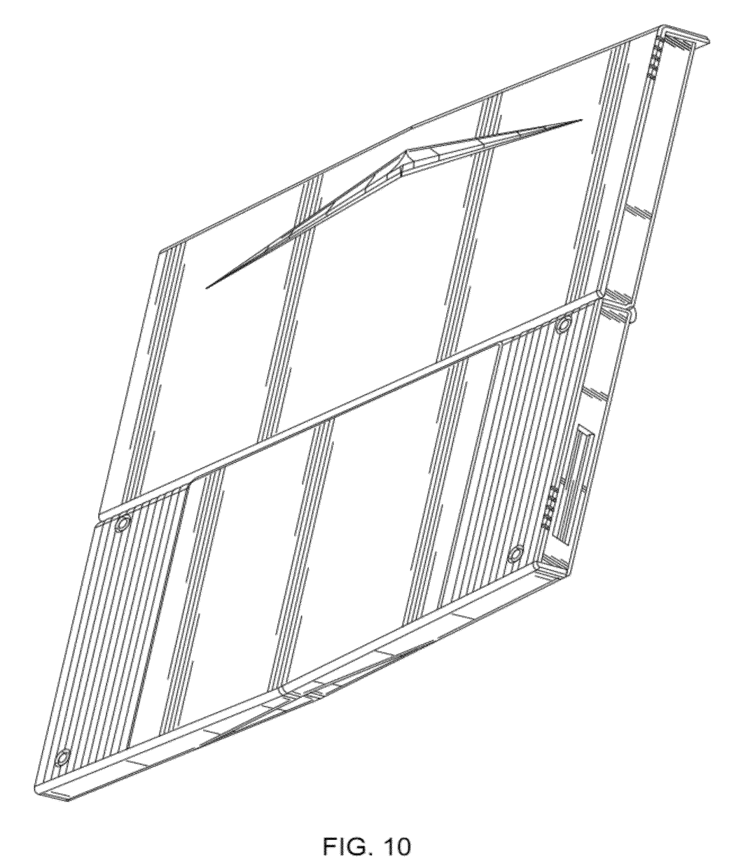

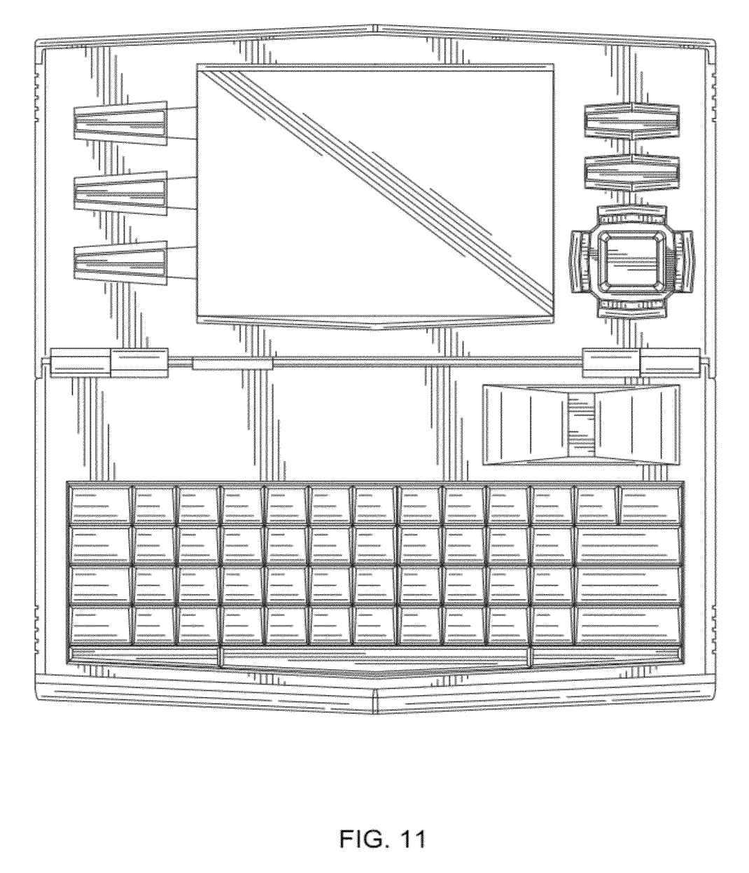

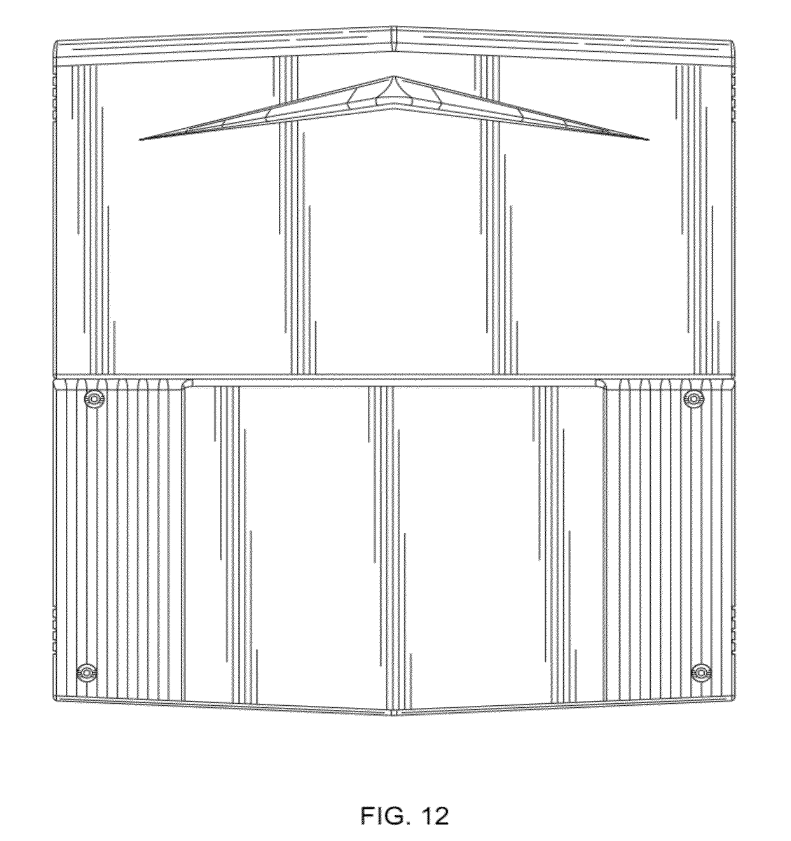

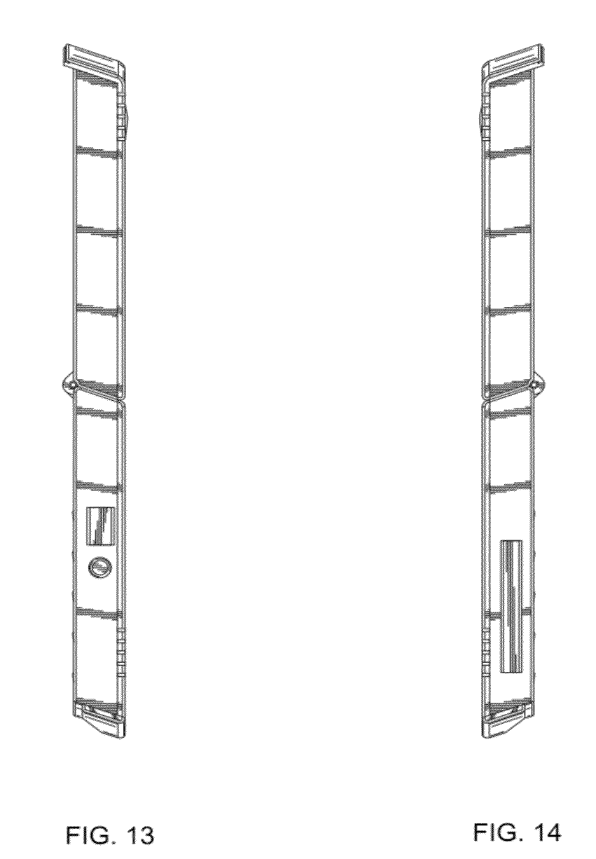

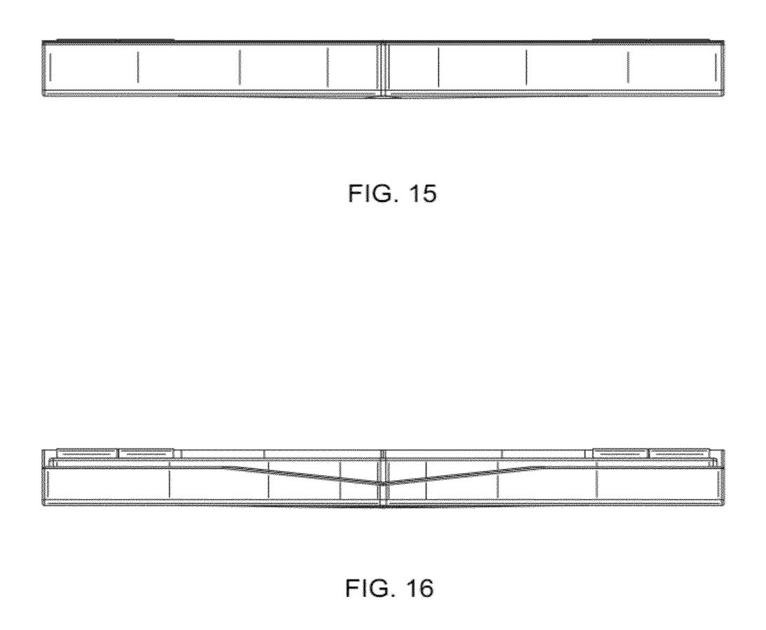

Referring to FIGS. 9-16 a second embodiment of the invention includes a biometric sensor, such as a fingerprint sensor, above the keyboard on the lower half of the clamshell case. On the upper half of the clamshell case to the right of the screen, there is a rocker switch (cursor control) below a BACK button and a HOME button. On the left of the screen there are three context-sensitive buttons. The rocker switch and BACK and HOME buttons allow the user to navigate a menu-based user interface. The context-sensitive buttons provide account-management specific options that fit the options available in particular contexts. This can allow it to provide all of the functions of the first embodiment with fewer keys. The command structure is designed such that, once the user has initialized the database, the user can perform routine access and management functions using only the top half, which has been designed to be cradled in the user's hand in an ergonomically designed position. The functions provided on the top half include at least functions for accessing data, adding data, updating data, and deleting data.

The keyboard is a QWERTY keyboard that has been designed with keys of a sufficient size to allow for easy entry of text by most adults. This helps to ensure that users can comfortably use the device on an ongoing basis to enter the constant additions of and updates to confidential account information that tend to arise in the course of managing one's household finances. More specifically, the key sizes and locations on the keyboard were designed in accordance with recommended standards Published by the Human Factors and Ergonomics Society to allow most adult users of both sexes to use the device comfortably in a typing position with both hands simultaneously. Through testing, it was determined that measurements of 5¼ inches by 3¼ inches by ¾ inches (closed) provide an appropriate level of both usability and portability for non-professional users when they are accessing confidential account information. This testing also indicates that in some contexts some departure from these numbers (e.g., up to about 8 inches wide or down to about 4.5 inches wide) could provide value in some circumstances. A professional banker, for example, might be willing to sacrifice some portability for the sake of ease-of-use, while a person who travels frequently might be more interested in portability than in ease-of-use. Lower thicknesses are generally preferable, but can be hard to achieve and may not be essential for all applications. The second embodiment also employs a simple interlocking plastic snap closure coupled with a magnetic switch, which turns the device on when the case is open and turns it off when the case is closed.

The second embodiment uses an SD card to back up the data on the device, which can be formatted according to a proprietary format. It does not use a USB drive or connect to a computer or communication network. This kind of designed-in isolation enhanced security by reducing the chance that the device could be probed by malicious software through the USB port. The backup device can store user settings in addition to the user's account data.

The backup drive is designed to provide a number of security features. First, the data from the device can be encrypted using the user's password. This can prevent an individual who comes into possession of the backup drive from accessing the stored data.

The backup drive can also be designed to provide device-level or user-level security. In this case, the data can also be encrypted using a device-specific password and/or a user account-specific password. This can prevent an individual from even trying to guess the user's password after inserting the backup device into another portable confidential account information management device of the same type. In some instances, the user may be required to obtain his or her account-specific password from a trusted source, such as a device manufacturer, after his or her identification has been verified.

The backup drive can further employ a proprietary format to make it harder to access with other types of third-party devices. This approach can provide a number of different kinds of impediments to access using other types of devices, such as the use of a non-standard file structure, a non-standard connector pin-out, or a non-standard physical form factor. The backup drive can also contain a unique embedded access code only recognized by the apparatus.

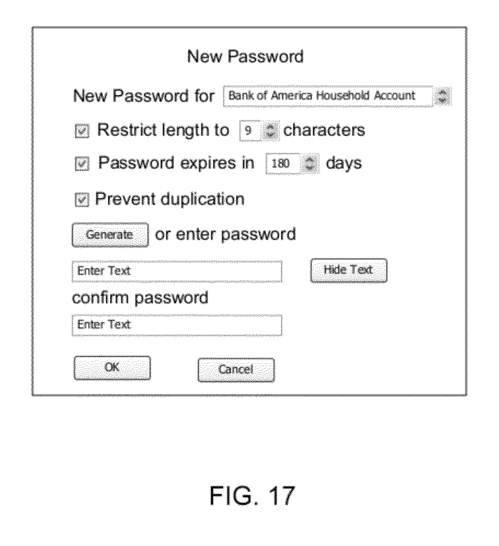

Referring to FIG. 17, the second embodiment of the portable confidential account information management device can provide versatile and secure password creation functions. These can include the ability to set a minimum password length, to set a password expiration deadline, to require that a password not match any other password in the device, and to robustly generate passwords.

The device can also include a GPS location/remote erase module. This module allows the user to determine a location of the device if it is lost or misplaced and/or remotely cause the contents of the device to be irretrievably erased. This type of functionality, like accidental lockout override, is preferably accessed via a trusted organization to reduce the possibility of fraud.

The present invention has now been described in connection with a number of specific embodiments thereof. However, numerous modifications which are contemplated as falling within the scope of the present invention should now be apparent to those skilled in the art. It is therefore intended that the scope of the present invention be limited only by the scope of the claims appended hereto. In addition, the order of presentation of the claims should not be construed to limit the scope of any particular term in the claims.

What is claimed is:

1. A portable confidential account information management device, comprising:
a biometric sensor,
a keyboard,
a processor,
storage including:
account information storage including fields that each include:
an account identifier field, and
a password field associated with the account identifier field, program storage including native account management software that is operative to run on the processor and is responsive to the biometric sensor and to the keyboard to enable retrieval of contents of the account identifier field and the password field for selected accounts, and
a display screen responsive to the account management software and operative to display the retrieved contents of the account identifier field and the retrieved password field for each of the selected accounts.

2. The apparatus of claim 1, further including:
a power source for the processor,
a power switch responsive to the power source, and
boot logic responsive to the power switch and operative to run the native account management software upon activation of the power switch.

3. The apparatus of claim 2 further including clam-shell housing to hold the biometric sensor, keyboard, storage, and display screen, and wherein the power switch is a magnetic switch operative upon opening and closing the clam-shell housing.

4. The apparatus of claim 1 further including keys whose function is specific to account management functions of the native account management software.

5. The apparatus of claim 1 wherein the program storage is non-volatile storage.

6. The apparatus of claim 1 wherein the program storage includes only a single operating system program that includes the native account management software.

7. The apparatus of claim 1 wherein the storage includes a closed operating system program that runs the native account management software.

8. The apparatus of claim 1 wherein the portable confidential account information management device is isolated from all communication networks.

9. The apparatus of claim 1 wherein the portable confidential account information management device is isolated from all wireless networks.

10. The apparatus of claim 1 wherein the portable confidential account information management device is isolated from all public networks.

11. The apparatus of claim 10 wherein the portable confidential account information management device includes no public network communication functionality.

12. The apparatus of claim 1 wherein the portable confidential account information management device weighs 0.5 lb or less.

13. The apparatus of claim 1 wherein the portable confidential account information management device weighs 1 lb or less.

14. The apparatus of claim 1 wherein the portable confidential account information management device weighs 3 lbs or less.

15. The apparatus of claim 1 further including a navigation control disposed adjacent the display screen and wherein the native account management software is responsive to the navigation control to select accounts for which account information and passwords are displayed.

16. The apparatus of claim 15 wherein the pointing device includes touch-screen hardware associated with the display.

17. The apparatus of claim 1 wherein the portable confidential account information management device includes one or more third-party promotional insignia.

18. The apparatus of claim 1 wherein the native account management software in the program storage includes:
encryption software to encrypt at least the contents of the password fields in the account information storage, and
decryption software to decrypt at least the contents of the password fields in the account information storage.

19. The apparatus of claim 1 wherein the program storage includes device access software responsive to the keyboard to prompt for and receive a device lockout password from the user and to exclude access to the device unless a predetermined password is received from the user.

20. The apparatus of claim 19 wherein the program storage further includes AND logic responsive to the device access software and to the biometric sensor to exclude access to the device unless a predetermined combination of device lockout password and biometric information is received from the user.

21. The apparatus of claim 1 wherein the native account management software in the program storage includes a password generator and wherein the password fields in the account information storage are responsive to the password generator to directly store passwords generated by the password generator.

22. The apparatus of claim 1 wherein the native account management software in the program storage includes password evaluation logic.

23. The apparatus of claim 22 wherein the password evaluation logic is operative to evaluate password strength.

24. The apparatus of claim 22 wherein the password evaluation logic is operative to evaluate password length.

25. The apparatus of claim 1 wherein the native account management software in the program storage includes duplicate password detection software responsive to a plurality of the password fields in the account information storage to detect duplication between passwords stored in the password fields.

26. The apparatus of claim 1 further including a location detection system.

27. The apparatus of claim 26 wherein the location detection system includes a GPS receiver and a wireless location reporting transmitter operative to transmit a GPS location signal.

28. The apparatus of claim 1 wherein the keyboard is a QWERTY keyboard.

29. The apparatus of claim 28 wherein a width of the keyboard is at least about five and one-quarter inches.

30. The apparatus of claim 28 wherein a width of the keyboard is no more than about six inches.

31. A password storage method, comprising:
storing passwords in dedicated password storage fields,
storing account information in dedicated account information fields,
isolating the passwords and the account information from all public networks, and
restricting access to the passwords using dedicated password access logic.

32. A portable confidential account information management device, comprising:
a keyboard,
a processor,
storage including:
account information storage including fields that each include:
an account identifier field, and
a password field associated with the account identifier field, program storage including native account management software that is operative to run on the processor and is responsive to the keyboard to enable retrieval of contents of the account identifier field and the password field for selected accounts,
a display screen responsive to the account management software and operative to display the retrieved contents of the account identifier field and the retrieved password field for each of the selected accounts, and
a removable portable data storage device port responsive to the storage to store backup copies of information stored in the account information storage.

33. The apparatus of claim 32 wherein the native account management software has the functionality to create a duplicate of the data memory from the portable confidential account information management device on the portable data storage device as needed.

34. The apparatus of claim 33 wherein the native account management software has the functionality to further create a duplicate of existing user settings from the portable confidential account information management device.

35. The apparatus of claim 32 wherein the native account management software has the functionality to recover data stored on the portable data storage device as needed.

36. The apparatus of claim 32 wherein the native account management software contains security protocol that can only operate with a combination of a specially constructed portable data storage device in conjunction with a unique user-generated access code.

37. The apparatus of claim 32 wherein the portable confidential account information management device is constructed to operate in connection with a specially constructed portable data storage device that includes at least one access-restriction feature.

38. The apparatus of claim 37 wherein the access-restriction feature of the specially constructed portable data storage device includes a proprietary storage format.

39. The apparatus of claim 37 wherein the access-restriction feature of the specially constructed portable data storage device includes a proprietary form factor.

40. The apparatus of claim 32 wherein the native account management software provides secure data back-up and recovery with a security access protocol designed to only interact with a certain portable memory device that contains a unique embedded access code only recognized by the apparatus.

41. The apparatus of claim 32 wherein an additional level of security for data back-up and recovery operation is provided by the apparatus native account management software through the creation and recognition of a unique user-generated access code required for the apparatus to conduct any memory back-up and recovery operation.
